(19) United States
(12) Patent Application Publication
(10) Pub. No.: US 2004/0054789 A1
(43) Pub. Date: Mar. 18, 2004

(54) Pervasive home network portal

(75) Inventors: Jochen Breh, Marbach (DE); Gerd Breiter, Wildberg (DE); Hendrik Wagner, Stuttgart (DE)

Correspondence Address: Mark E. McBurney, Intellectual Property Law Dept., IBM Corporation, 11400 Burnet Road, Austin, TX, 78758, US

(73) Assignee: International Business Machines Corporation, Armonk, NY

(21) Appl. No.: 10/242,234

(22) Filed: Sep. 12, 2002

(51) Int. Cl. G06F 15/16

(52) U.S. Cl. 709/229

(57) ABSTRACT

According to the present invention a method and a system is provided for organizing access and control from a user to an appliance via a distributed information system by employing a mediator. First a message is received from the user containing a generic command, which is then converted into an appliance specific command. Subsequently, the appliance specific command is sent to the appliance to be processed and a response message is received from the appliance. Finally, the response message is converted into a generic format and sent back to the user. The present invention provides an easy-to-use interface for users to all their pervasive home network devices.

### CROSS REFERENCE TO RELATED APPLICATIONS

The present invention is related to the subject matter of the following commonly assigned copending U.S. patent application, “Pervasive Home Network Appliance”, having Ser. No. ______, docket no. DE9-2001-0094, and filed concurrently herewith.

### BACKGROUND OF THE INVENTION

1. Field of the Invention

The present invention generally relates to the field of user interfaces for devices. Particularly, the present invention relates to providing web access and control functionality to provide enhanced and widely accessible user interface functions. More particularly, the present invention relates to a method and system for organizing access and control from a user to an appliance via a distributed information system by employing a mediator.

2. Description of the Related Art

In the last few years there could be noticed a desire for an extension of home automation. Together with the increasing networking and wireless communication technology the technical vision of a smart home controlled via the Internet now seems to be more realistic than ever before. Affordable wireless devices may build the backbone of smart homes. Another positive factor is the high percentage of private homes already having access to the Internet.

The so-called smart home contains sensors like temperature feelers, movement alarm units and even video cameras. These devices pass their data to a control device, which in turn controls actuators such as heaters, window shutters, lawn sprinklers, etc. If applicable, the control unit sends notifications via new communication media, such as cell-phone, e-mail or pager to the users. The sensors may even be placed far away from the home device to be controlled.

From U.S. Pat. No. 6,098,893 by Ulf Stefan Berglund et. al., assigned to Honeywell Inc., Minneapolis, Minn., USA, filed Oct. 22, 1998, issued Aug. 8, 2000, “Comfort control system incorporating weather forecast data and a method for operating such a system” a comfort control system for multiple buildings is known (whether residential, commercial or industrial). In such a system, a weather forecast unit sends weather forecast data over the Internet to a building management provider which handles building management services for a number of clients, each having a number of buildings and properties. At the provider's reception station, data on the external-building characteristics of all the buildings is compiled with the received data and then fed to the appropriate building management controls system.

However, the control of home devices is not be limited to use of weather forecasts from a central data source and external building information to feed building management control systems.

A typical household contains several home devices. Home devices are often controlled using a single common control unit, namely a remote control device. This single common control unit allows a homeowner to control and command several different home devices using a single interface. Thus, many manufacturers have developed control units for controlling and commanding their home devices from a single interface.

One drawback associated with using the remote control unit to command and control home devices is that it provides static control and command logic for controlling and commanding each home device. Therefore, a particular remote control unit can only control and command those home devices for which it includes the necessary control and command logic. For example, if a remote control unit comprises logic for controlling a television (TV), a video cassette recorder (VCR), and a digital video device, but not a compact disk (CD) unit, the remote control unit can not be used to command and control the CD unit. In addition, as new home devices are developed, the remote control unit will not be able to control and command the new home devices that require control and command logic that was not known at the time the remote control unit was developed.

Therefore, U.S. Pat. No. 6,198,479 by Richard James Humpleman et. al, assigned to Samsung Electronics Co., LTD, Suwon, Republic of Korea, filed Jun. 24, 1998, issued Mar. 6, 2001, “Home network, browser based, command and control” suggests a method and system for commanding and controlling diverse home devices on a home network to perform a service. According to the method, a client device that is capable of displaying a user interface is connected to a home network. A software agent is executed on the client device to cause a user interface to be displayed on the client device. First and second home devices connected to the home network are selected from the user interface, and control and command data are sent from the client device to the first and second home devices to cause these devices to communicate with each other to perform the service.

Thus, each device has to provide HTTP (Hypertext Transfer Protocol) and TCP/IP (Transmission Control Protocol over Internet Protocol) functionality. However, this might add severe complexity to each device which may not be acceptable in certain cases.

U.S. Pat. No. 5,956,487 by Chandrasekar Venkatraman et. al., assigned to Hewlett-Packard Company, Palo Alto, Calif., USA, filed Oct. 25, 1996, issued Sep. 21, 1999 “Embedding web access mechanism in an appliance for user interface functions including a web server and web browser” teaches how web access functionality is embedded in a device to enable low cost widely accessible and enhanced user interface functions for the device. A web server in the device provides access to the user interface functions for the device through a device web page. A network interface in the device enables access to the web page by a web browser such that a user of the web browser accesses the user interface functions for the device through the web page. Again web access functionality is embedded in each device.

In the White Paper “The Connected Home Powered by Java Embedded Server Software” by Sun Microsystems, Inc., Palo Alto, Calif., USA, 2001, a connected home is described. It connects all of the networks that already exist in the home—electrical, telephone, wireless—and then connect each one with any number of external networks via the Internet. This is done using a home gateway that could be a cable modem, a set top box, a DSL modem, a web phone or a dedicated residential gateway device. The specialized hardware and software required for a gateway can be built into a new, specialized device or embedded into an existing device. In effect, adding an embedded server—a special-purpose, low-memory, software server (not a Web server)—to any broad band termination device, transforms it into a home gateway. Preferably, a Java Embedded Server and Java enabled devices are employed.

Yet again, web access functionality is embedded in each device, i.e., in order to implement a connected home as described every single device needs to be Java enabled.

Starting from this, the object of the present invention is to provide a method and a system that makes devices accessible via a distributed information system, such as the Internet.

The foregoing object is achieved by a method and a system as laid out in the independent claims. Further advantageous embodiments of the present invention are described in the sub claims and are taught in the following description.

### SUMMARY OF THE INVENTION

According to the present invention a method and a system is provided for organizing access and control from a user to an appliance via a distributed information system by employing a mediator, also referred to as an arbiter. First a message is received from said user containing a generic command, then, said generic command is converted into an appliance specific command. Subsequently, said appliance specific command is sent to said appliance to be processed and a response message is received from said appliance. Finally, said response message is converted into a generic format and sent back to said user.

The present invention provides an easy-to-use interface for users to all their home devices. All home devices connected to said appliance are now referred to as Pervasive Home Network Devices. For details of various connection implementations see applicant's aforementioned copending patent application “Pervasive Home Network Appliance”, docket number DE9-2001-0094.

The present invention is applicable to several levels of user interfaces, simple ones, like query and control, and also complex ones defining rules for condition processing. Furthermore, the Pervasive Home Network Portal according to the present invention defines interfaces for service providers. Thus, it is possible for a service provider to offer additional services (weather, security, etc.) based on of data gathered by the Pervasive Home Network Devices.

In order to allow independence from device manufactures, the Pervasive Home Network Portal according to the present invention defines interfaces for the software presenting Pervasive Home Network Device data to the users. So, a device manufacturer can plug the appropriate graphical end user interface into the Pervasive Home Network Portal. This may be achieved by using techniques such as remote portlets combined with underlying Web Services technologies, e.g., XML (Extensible Markup Language), SOAP (Simple Object Access Protocol), UDDI (Universal Description, Discovery and Integration). Portlets are Java classes similar to servlets. They are running in a portlet engine like apache jakarta-jetspeed and generate HTML-Output, but unlike servlets, this HTML-Output is not a complete page, but consists only of HTML fragments combined to a complete page by the portlet engine using multiple portlets.

With the present invention manufacturers of Pervasive Home Network Devices are enabled to offer appropriate portlets for presenting device data to the user. These portlets also can also be used for manipulating the devices. They can either be operated within the Pervasive Home Network Portal (local) as well as on the manufacturers premises (remote portlets).

Interfaces may be defined for sending the appropriate Pervasive Home Network Appliance Device Adapter from the Pervasive Home Network Portal to the user's Pervasive Home Network Appliance (For a description of Device Adapter in conjunction with the Pervasive Home Network Appliance see the aforementioned, copending patent application, “Pervasive Home Network Appliance, docket no. DE9-2001-0094). With the concept of the present invention it is possible for the users to install a Pervasive Home Network Device at their home and to find the appropriate graphical user interface automatically in the Pervasive Home Network Portal on their next log-on to the portal.

The following brief description illustrates the functionality of the present invention. First, the user logs on to the Pervasive Home Network Portal. Then, the Pervasive Home Network Portal checks the user's authentication and establishes a connection to the Pervasive Home Network Appliance. After this has been done, the Pervasive Home Network Appliance is able to query and control all attached Pervasive Home Network Devices. Because of this, the user is enabled to query and control all Pervasive Home Network Devices via his web browser. Furthermore, the user can define rules and conditions for automated actions between the Pervasive Home Network Portal and the Pervasive Home Network Appliance with the Pervasive Home Network Devices attached to it, without further user interactions (user is off-line). As used herein home network devices include, but are not limited to heaters, air conditioners, window shutters, kitchen appliances, electronic devices, such as VCRs, DVDs, stereos, spas, and other such environmental regulating devices.

The system according to the present invention advantageously allows the user to define rules and conditions referring to additional service providers. The additional service providers, e.g. provide events, such as an indication that it has started to rain in a specific area, or a value, such as, the temperature. Additional targets for event notification are also contemplated, such as, automated mobile phone call, e-mail, SMS (Short Message Service), Unified Messaging, i.e., the handling of voice, fax, and regular text messages as objects in a single mailbox that a user can access either with a regular e-mail client or by telephone.

The main components of the Pervasive Home Network Portal will now be described. The Pervasive Home Network Portal comprises an Administration/Authentication Part, a Query Part, a Basic Control Part, a Comfort Control Part, a Condition Agents Part and an Alarm/Event Management Part.

The Administration/Authentication Part checks the user's authentication when the user logs on to the Pervasive Home Network Portal. In addition with this part the user is able to administer the Pervasive Home Network Devices. That is, the user can change its configuration by adding or removing Pervasive Home Network Devices.

With the Query Part the user can query single Pervasive Home Network Devices by sending appropriate commands to a specific Pervasive Home Network Device. The Basic Control Part enables the user to control single Pervasive Home Network Devices by sending appropriate commands to a specific Pervasive Home Network Device. Whereas, the Comfort Control Part allows the user to store a set of commands dedicated for several Pervasive Home Network Devices. Then, whenever the user selects a previously stored set, all commands are sent to the appropriate Pervasive Home Network Devices sequentially. Such a set, a so called “scene”, can be used for situations, occurring more than once, e.g., “nobody at home” or “will arrive in a hour”.

The Condition Agents Part enables the user to define a set of rules that transform incoming events (condition is met) to outgoing commands and scenes. Incoming events may either be events generated by Pervasive Home Network Devices of the user or events provided by additional Service Providers, e.g., a weather service. Outgoing commands and scenes may either be directed to the user's Pervasive Home Network Devices or to additional Service Provider transforming this command to messages within other communication media, such as Universal Messaging, e-mail, etc.

The Alarm/Event Management Part enables the user to define, which action has to be taken, in case a specific event occurs within the Pervasive Home Network Devices, e.g., dependent on the day of week, the time of the day or the month. Alarm messages may be routed to different locations. In case of a person suffering, e.g., from a heart disease, an alarm may be routed to the family doctor during the day and directly to an ambulance center after hours.

An Additional Service Provider may be connected to the Pervasive Home Network Portal offering various services. It may either provide events and values, e.g., related to the weather within a specific region or algorithms, that can be used by the user defined rules. For example, a heating manufacturer may provide optimized heating parameter for its appliance, dependent on various input parameters. An Additional Service Provider may also offer message services delivering events in various formats to the user via all kinds of communication media.

The Server and Communication Part is not visible to the user of the Pervasive Home Network Portal, but it defines interfaces necessary for all higher level parts and controls such higher level parts accordingly. There are interfaces for the end user interface as well as for the command and event processing. Additionally it provides the communication resources necessary to establish the connections to the Pervasive Home Network Appliances.

There are a lot of scenarios which can be envisioned to work with the method and system according to the present invention. It can be used in remote security scenarios. End clients using the high level system above do not need any remote security support, since they can define in the system what should happen, when an intrusion detector is signaling an alarm. They can decide for example to first check through remote surveillance cameras (online) and if they detect something, to start additional actions.

Access control of buildings could be done in a way that the request for access into a house is handled through the portal from a remote location and the owner of the house in turn is able to grant the access through the portal after checking via a surveillance camera who wants to get access.

Other scenarios which are possible through the integration of different devices of different providers (e.g. sensors and controlling devices) and the interaction with third party information providers like weather channels or energy companies are the use of automated control algorithms with additional parameters provided by these companies. Possible scenarios could be, for example, weather dependent control of house devices (shutters and/or windows in case of storm/sunshine etc.) This type of solution is in a lot of cases more effective when only using the information provided by the sensors installed in the house. For example watering the lawn has to be done before it actually gets hot, so one has to know in advance when to start the lawn sprinkler based on this information. There are already plans of the energy companies to provide information about their actual energy capacity and to charge the user based on their available capacity. So in case of over capacity energy consuming devices such air conditioners or pool heaters could be run or stopped depending on that information. Therefore the system described above stores user preferences and makes adjustments to home appliances based on time or cost of electricity.

The present invention supports scenarios such as the control of devices before arrival (refrigerator, swimming pool, air conditioner)—scenes, remote damage observation (water damage, gas, fire) or remote damage prevention (e.g. preventing pipes from freezing by turning on hot water). The system can also be used in various safety scenarios, such as remote support for handicapped people. It can be easily extended to health care scenarios, e.g. remote blood pressure measurement.

In addition to using the system of the present invention for home automation it can be used for machine management within hotels, plants, factories, industrial installations, or other such facilities. Any environments, where data is gathered by measurement devices, and actions are triggered by control devices (e.g. remote service) are candidates for the invention described herein.

One major advantage of the present invention is that information relating to devices of different vendors can be combined and, based on that information, actions can be performed by various devices independent of their supplier, i.e. action can be taken on devices having the same or a different provider. For example, the owner of a house can start with a very few devices only and add additional devices of other suppliers, as needed.

The present invention provides an infrastructure that will utilize the proprietary control and measurement devices from various vendors which are used in the homes (and in some case the controlling software), and which can be connected or plugged together. A business model based on the present invention may enhance revenue stream of the various device manufacturers, by creating a new value chain in which those manufacturers could participate.

The above, as well as additional objectives, features and advantages of the present invention, will be apparent in the following detailed written description.

### BRIEF DESCRIPTION OF THE SEVERAL VIEWS OF THE DRAWINGS

The novel features of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 shows a general block diagram which illustrates a system in accordance with the present invention;

FIG. 2 shows a more detailed block diagram of an embodiment according to FIG. 1;

FIG. 3 shows a flowchart illustrating a method of registering a user in accordance with the present invention;

FIG. 4 shows a flowchart illustrating a method of processing a logon request of an user in accordance with the present invention;

FIG. 5 shows a flowchart illustrating a method of querying digital information from devices connected to the appliance in accordance with the present invention;

FIG. 6 shows a flowchart illustrating a method of setting digital information within devices connected to the appliance in accordance with the present invention;

FIG. 7 shows a flowchart illustrating a method of using scenes in accordance with the present invention;

FIG. 8 shows a flowchart illustrating a method of an automated rules processing in accordance with the present invention;

FIG. 9 shows a flowchart illustrating a method of an automated rules processing including the invocation of additional service providers in accordance with the present invention;

FIG. 10 shows a flowchart illustrating a method of a registration of a service provider to a portal in accordance with the present invention;

FIG. 11 shows a flowchart illustrating a method of changing the configuration of the user's devices by adding a new device in accordance with the present invention.

### DETAILED DESCRIPTION OF THE INVENTION

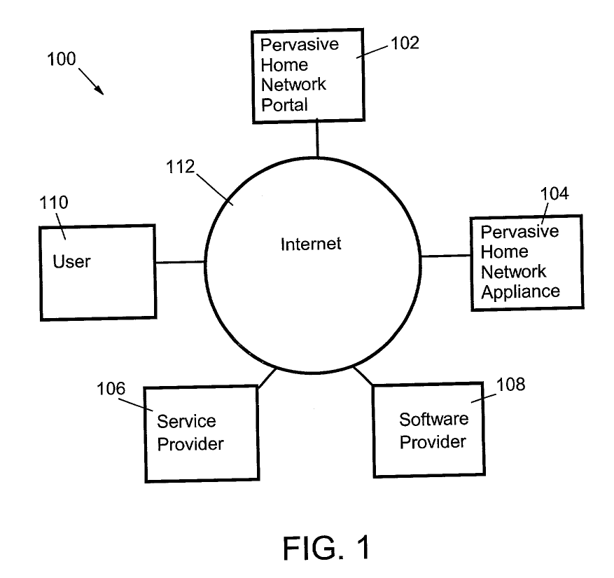

With reference now to FIG. 1, there is depicted a general block diagram which illustrates a system 100 in accordance with the present invention. The system 100 comprises a Pervasive Home Network Portal 102 (portal), a Pervasive Home Network Appliance 104 (appliance), a service provider 106, a software provider 108 and a user 110, which are all connected to a distributed information system, such as the Internet 112.

The portal 102 provides means to access and control devices at the user's home, whereby the user 110 communicates with the portal 102 preferably via the Internet. The portal 102 uses the appliance 104 for establishing a communication link to devices at the user's home which are not directly connected to the Internet. So the user gets enabled to query and control his devices via the Internet. The user 110 additionally can define rules for having his devices automatically controlled by the service provider 106.

After having installed a new device in the home, a user can use control and presentation software offered to him by the software provider 108. All such parts are connected via the Internet 112 and communicate and exchange information in this infrastructure as explained in further detail below. That is, an explanation is provided as to which interactions between portal 102, the appliance 104, the service provider 106 and the software provider 108 are performed, so that the user 110 finally can benefit from the unified view to the devices located in the home. The communication links established between the various components may be formed by a distributed information system, such as the Internet. The communication link may partly or entirely be formed by a wireless communication connection, such as Bluetooth, GSM (Global System for Mobile Communications), GPRS (General Packet Radio Service), UMTS (Universal Mobile Telecommunications System).

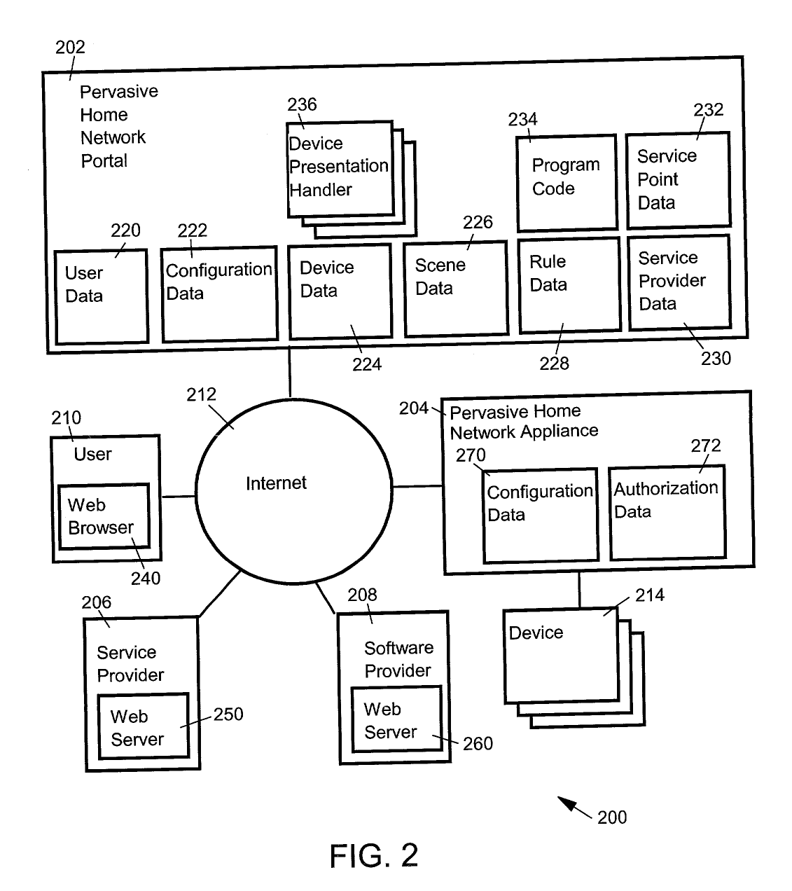

With reference to FIG. 2, there is depicted a more detailed block diagram of a system 200 according to FIG. 1. In addition, the drawing of FIG. 2 shows the components within the parts, namely, a Pervasive Home Network Portal 202 (portal), a Pervasive Home Network Appliance 204 (appliance), a service provider 206, a software provider 208 and a user 210, all connected to a network, such as the Internet 212. The Pervasive Home Network Appliance 204 is further connected to one or more devices 214 which are located in the user's home.

The portal 202 comprises storage devices for storing user data 220, configuration data 222, device data 224, scene data 226, rule data 228, service provider data 230, service point data 232, program code 234 and device presentation handlers 236.

The user data 220 includes data like an identification of the user 210, the user's address and telephone number. It may be stored in a commercial database system.

The configuration data 222 describes the devices 214. They may also be stored in a database system.

The device data 224 includes data collected by the devices 214. Therefore, the collected data might be derived by detecting, monitoring states and/or events in the user's home. As an example, the actual temperature in the user's home may be stored here. Again, these data may be stored in a database system.

The scene data 226 are defined by the user 210 as a collection of commands. They may also be stored in a database system. The expression “scene” basically refers to a predetermined behavior of the system in response to a user driven event. When the user 210 activates a scene, the scene data 226 are retrieved and every command is sent to the appropriate device to be executed.

The rule data 228 are also defined by the user and may be stored in a database system. The rule data 228 specify a predetermined behavior of the system in response to an occurrence of a particular scenario as set by the user. Whenever an event occurs that indicates the occurrence of a particular scenario, the appropriate rule is retrieved. As a result of the interpretation of such a rule, a collection of commands is produced, which in return is sent to the user's devices to be executed.

The service provider data 230 describe the way to invoke the service provider 206. Such data may, e.g., be composed by a SOAP (Simple Object Access Protocol) call, whereby SOAP is formed by a minimal set of conventions for invoking code, i.e., instructions for a computer in some programming language, using XML (Extensible Markup Language) over HTTP (Hypertext Transfer Protocol). The service provider data may again be stored in a database system.

The service point data 232 consists of data produced in response to invoking a service provider 206. Such data may be stored in a database system.

The program code 234 is a collection of executable code. It may be realized, e.g., by archive files, such as Java archive files, so called jar files, i.e., a compressed archive file containing Java class files, stored in BLOBS (binary large objects) in a database system.

In one embodiment, all data components previously described with the exception of the program code 234 can be represented in XML.

Like the program code 234, the device presentation handler 236 is executable code as well. It may be realized for example by Java Servlets, i.e., Java programs that run as part of a network service, typically an HTTP (Hypertext Transfer Protocol) server and respond to requests from clients, or by SOAP services running on a server like an Apache server by The Apache Software Foundation. The device presentation handler 236 is configured to convert inbound requests originated by a web browser into a generic markup language document, such as an XML document. Thus, e.g., an HTTP request is converted into a device command that is dependent on the respective device by taking the particularities of the respective device into account. It may be formed by a predefined format, such as an XML structure. On the other hand, the presentation handler 236 is configured to convert device data that is dependent on the respective device into a form a web browser can render, i.e., conversion of a high-level object-based description into a graphical image for display. So, e.g., an XML-document containing device data may be transformed into HTML data. The generated HTML data now contains the information enclosed in the outbound replies of the respective device. In addition, the device presentation handler is also able to convert the XML-document containing device data into another XML Format, such as VoiceXML to be able to present the device data to the user 210, or WML (Wireless Markup Language). In case the device presentation handler has converted the device data into HTML, the user 210 is subsequently able to view the reply of his devices by using a commercial web browser 240, such as, a MS Internet Explorer browser by Microsoft Corporation or Netscape Navigator browser by Netscape Communications Corporation. In other words, the device presentation handler 236 is able to convert visual device commands to actual device commands for incoming request. For the outbound replies it is able to convert actual device data into visual device data.

The user 210 may be formed either by an individual person, a group of persons or a legal entity. The user wants to communicate with the Pervasive Home Network Portal 202, the Pervasive Home Network Appliance 204, the service provider 206 and the software provider 208 and the user 210 wants to access and/or control the devices 214 via the Internet 212.

The user 210 utilizes the web browser 240 in order to communicate, access and control the other participants, as mentioned above. The web browser 240 may be located on hardware, such as a personal computer, mobile phone (cellular phone) or personal digital assistant (PDA).

The service provider 206 usually comprises a web server 250 to offer web services to the portal 202. The web server 250 may be realized by a WebSphere web server available from International Business Machines Corporation, an Apache web server by The Apache Software Foundation, a Weblogic web server by BEA Systems, Inc., or the like.

The software provider 208 usually comprises again a web server 260 to offer software download services to the portal 202. The web server 260 may be realized by one of the aforementioned commercial web servers.

The Pervasive Home Network Appliance 204 as described in the aforementioned application comprises storage devices for keeping configuration data 270. The configuration data is a list of devices 214 attached to the Pervasive Home Network Appliance 204 and their properties, which is used to translate a device communication protocol to a protocol recognizable by portal 202 and user interface 210. This list may be a text file in a structured format, such as XML. The Pervasive Home Network Appliance 204 further comprises storage devices for keeping authorization data 272. The authorization data 272 includes information necessary to contact the portal 202 in case an event occurs, such as a URL (Uniform Resource Locator) or a phone number.

The device 214 may be formed by anyone of electronic devices that are typically found in the home, i.e., theater equipment, e.g., TVs, VCRs, stereo equipment, security systems and direct broadcast satellite services or (DBSS), also known as digital satellite services (DSS), sprinkler systems, lighting systems, microwaves, dishwashers, ovens/stoves, and washers/dryers or even an automobile. The device 214 is configured to communicate with the appliance. The communication may be established by a wireless or wired computer network, such as the one disclosed in U.S. Pat. No. 6,175,860 by Brian Paul Gaucher, assigned to International Business Machines Corporation, Armonk, N.Y., USA, filed Nov. 26, 1997, issued Jan. 16, 2001, “Method and apparatus for an automatic multi-rate wireless/wired computer network”, or Bluetooth.

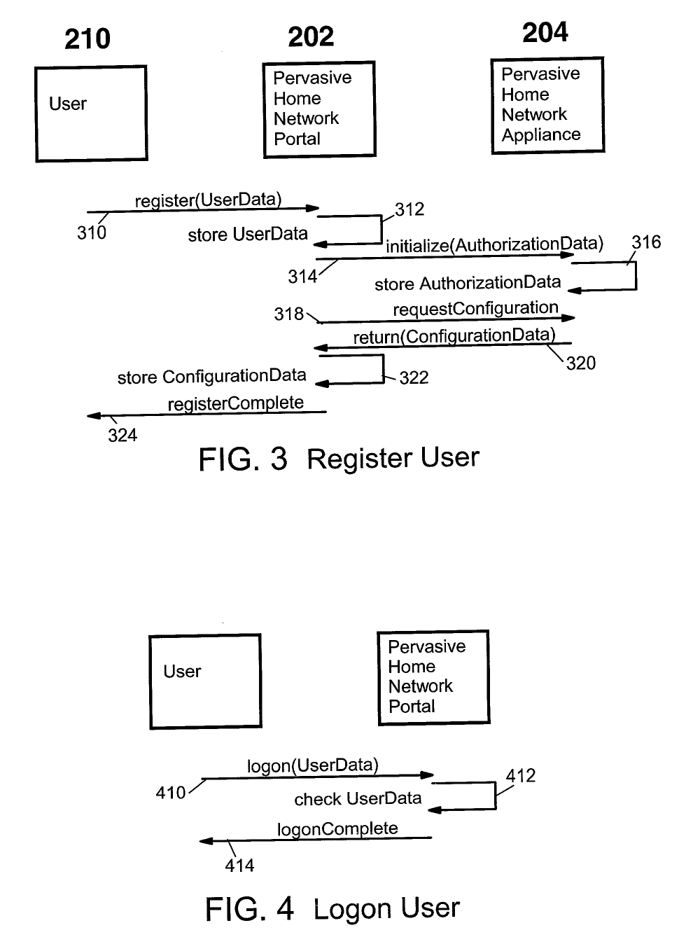

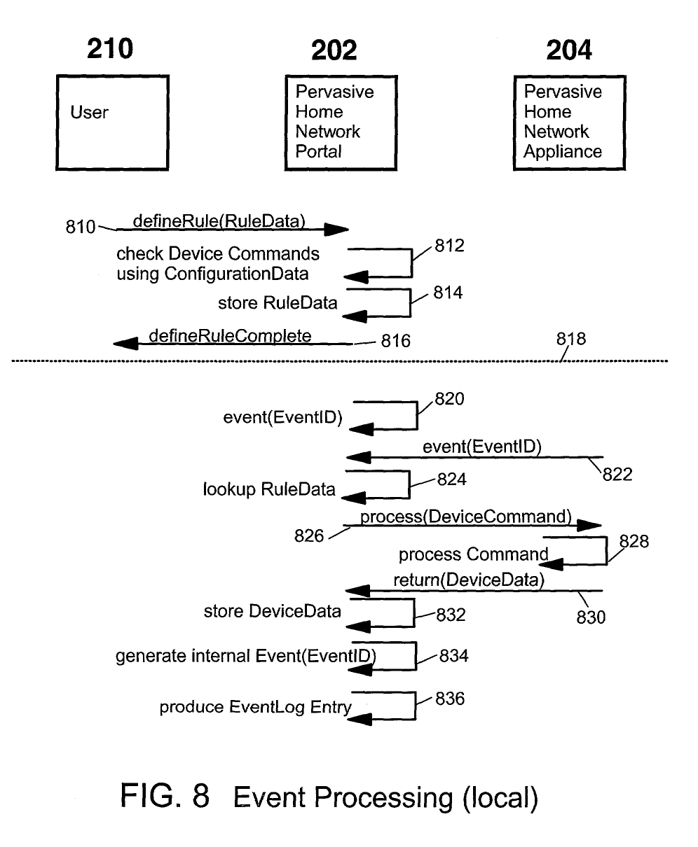

FIG. 3 is a flowchart illustrating a method of registering a user in accordance with the present invention. The communication takes place between the user 210, the portal 202 and the appliance 204. The arrows illustrate the steps of the method including the flow of information. In case a user wants to use a portal to control its devices via an appliance, a register event first must be sent to the portal (arrow 310). The portal stores the user data (arrow 312) and initializes the appliance (arrow 314) by sending authorization data. The appliance stores the authorization data (arrow 316), so it later can contact the portal in case an event occurs (see FIG. 8 for event processing). In the next step, the portal requests configuration data from the appliance (arrow 318). In response, the appliance returns the requested configuration data (arrow 320) and stores the configuration data in the respective storage device (arrow 322). In the last step, the portal sends a register complete reply to the user indicating that the register user process has successfully been performed (arrow 324).

With reference now to FIG. 4, there is depicted a flowchart illustrating a method of logging on the user 210 to the portal 202 in accordance with the present invention. This time, the communication takes place only between the user and the portal. Again, the arrows illustrate the steps of the method including the flow of information. Whenever, a user wants to log on to a portal, he sends a logon request to the portal containing user data, such as an identification of the user and a password (arrow 410). The portal now checks the user data against the stored user data from the register request (arrow 412, FIG. 3). If the User is authorized, a logon complete reply is sent to the user by the portal indicating that the log-on user process has successfully been performed (arrow 414).

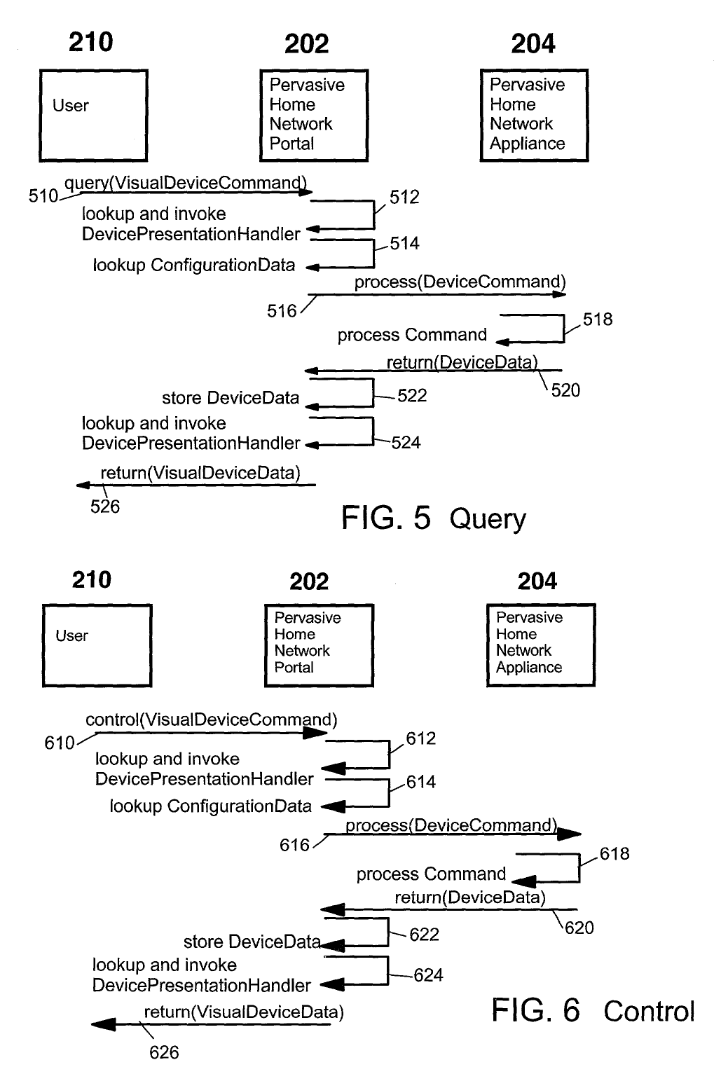

With reference now to FIG. 5, there is depicted a flowchart illustrating a method of querying digital information from devices connected to the appliance in accordance with the present invention. In this scenario, the communication takes place between user 210, a portal 202 and an appliance 204. Whenever a user wants to query the devices, contact is made to the portal by sending a query request containing a visual device command (arrow 510). A visual device command can for example be represented by a HTTP request. The portal, now, checks the visual device command, retrieves and invokes the appropriate device presentation handler and as a result, it obtains the appropriate device command (arrow 512). A device command can for example be represented by an XML document. The portal, then, extends the device command by retrieving the configuration data and adding data to the device command (arrow 514). Then, the portal sends a process request containing the device command to the appliance (arrow 516). The appliance, in return, processes the command (arrow 518) and sends the appropriate device data back to the portal (arrow 520). A device data may be represented by an XML document. Subsequently, the portal stores the device data (arrow 522) and then retrieves and invokes the appropriate device presentation handler (arrow 524) before sending the resulting visual device data back to the user (arrow 526).

With reference now to FIG. 6, there is depicted a flowchart illustrating a method of setting digital information within devices 214 connected to the appliance in accordance with the present invention. In this scenario, the communication takes place between the user 210, the portal 202 and an appliance 204. Whenever the user wants to control the devices, contact is made to the portal by sending a query request containing a visual device command containing information representing the action to be performed. This may be a new set of values to be stored in the device, such as new start and stop times for the sprinkler system to water the garden, or a new temperature value for the living room, or a command for directly controlling the device, such as a control sequence causing the air conditioning to switch on.

Such a visual device command may for example be represented by a HTTP request. The portal now checks the visual device command, retrieves and invokes the appropriate device presentation handler (arrow 612) and, as a result, it obtains the appropriate device command. The device command may be represented for example by an XML document. Then, the portal extends the device command by retrieving the configuration data and adding data to the device command (arrow 614). Then the portal sends a process request containing the device command to the appliance (616). The appliance, in turn, processes the command (arrow 618) and sends the appropriate device data back to the portal (arrow 620). The device data may also be represented by an XML document. Subsequently, the portal stores the device data (arrow 622) and then retrieves and invokes the appropriate device presentation handler (arrow 624) before sending the resulting visual device data back to the user (arrow 626).

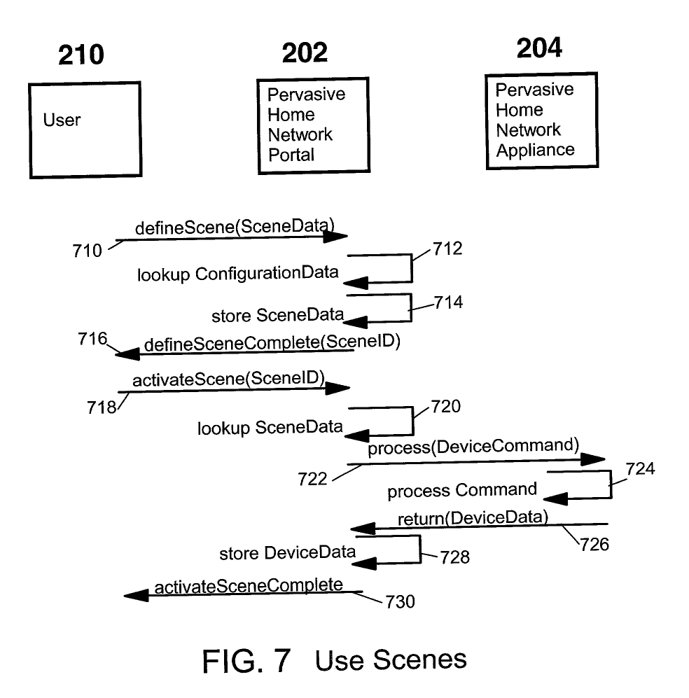

With reference now to FIG. 7, there is depicted a flowchart illustrating a method of using scenes in accordance with the present invention. In this scenario, the communication takes place between the user 210, the portal 202 and the appliance 204. In case a user wants to use a scene, it first must be defined to the portal. To do so, a define scene request is sent containing scene data, which includes a collection of device commands (arrow 710). The portal checks each device command by checking it against the configuration data (arrow 712). The configuration data is retrieved with user and device as search criteria. Then, the portal stores the complete scene data (arrow 714), produces a unique scene ID and returns the unique scene ID embedded in a define scene complete reply to the user (arrow 716). Later on, when the user wants to activate the scene, he sends an activate scene request to the portal containing the unique scene ID from the previous define scene complete reply (718). The portal retrieves the appropriate scene data (arrow 720) and then sends each device command with the process request to the appliance (arrow 722). The appliance processes the device command (arrow 728) and returns device data to the portal (arrow 726). After having stored all resulting device data for the scene (arrow 728), the portal returns an activate scene complete reply to the user (arrow 730).

With reference now to FIG. 8, there is depicted a flowchart illustrating a method of automated rules processing in accordance with the present invention. In this scenario, the communication takes place between the user 210, the portal 202 and the appliance 204. In case the user wants to have the devices automatically controlled a set of rules are first defined to the portal. For this purpose, a define rule request is sent containing rule data to the portal (arrow 810). The rule data contain rules, whereby one rule comprises two parts. The first part includes a condition evaluating device data and event IDs, whereas the second part contains a specification of an action to be performed in case the condition holds true.

A specified action may have two types: A device command to be sent to the appliance 204 and a new internal event to be raised (arrow 820). Whenever a condition holds true, the second part of the rule, i.e., the action, is performed. If one of the specified actions is a device command, the portal checks each device command using configuration data (arrow 812). The search criteria for retrieving the configuration data is the user and the device.

Then, the portal stores the complete rule data (arrow 814) and returns a define rule complete reply to the user (arrow 816). From this point in time to the actual occurrence of an event a period of time may pass as illustrated by the dotted line 818.

Whenever the event with the specified event ID occurs, either provided by the portal (arrow 820) or the appliance (arrow 822), the portal retrieves the appropriate rule data evaluates all conditions and performs all necessary actions (arrow 824). That is, when, an action is a device command, the portal sends the device command with the process request to the appliance (arrow 826). The appliance processes the device command (arrow 828) and returns device data to the portal (arrow 830). After having stored all resulting device data from the actions (arrow 832), the portal checks if the rule contains an action related to an internal event and generates this internal event, if necessary (arrow 834). In a last step, the portal appends an entry to an event log (arrow 836).

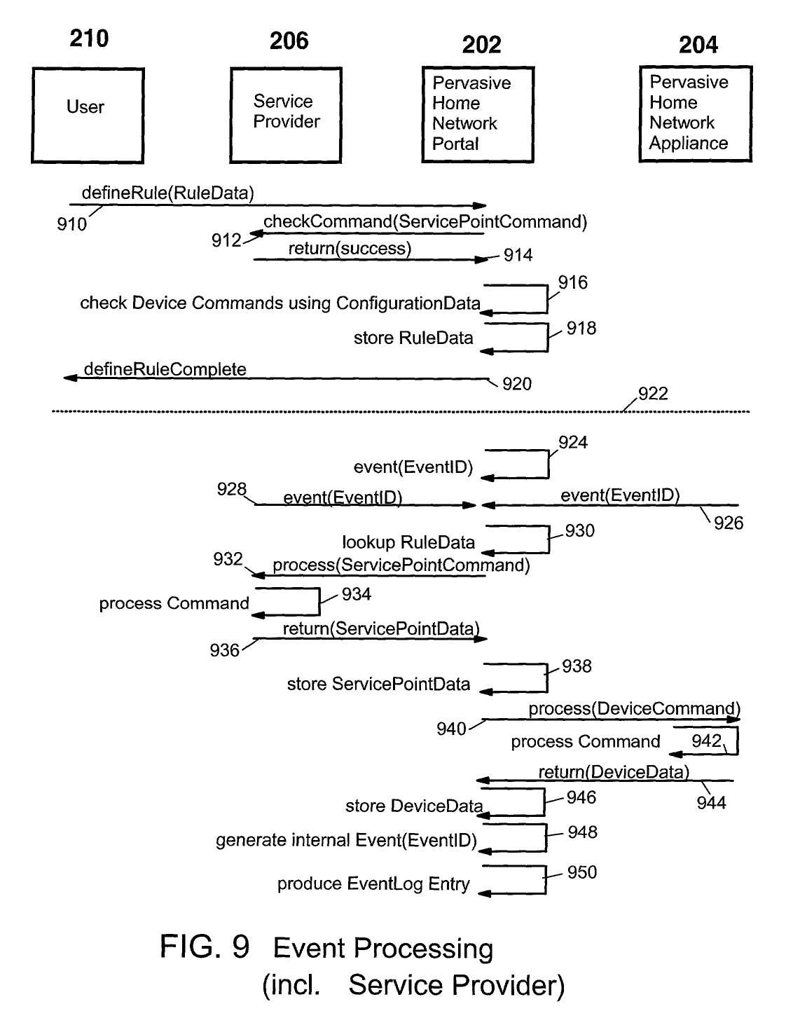

With reference now to FIG. 9, there is depicted a flowchart illustrating a method of an automated rules processing including the invocation of additional service providers in accordance with the present invention. In this scenario, the communication takes place between the user 210, the portal 202, the service provider 206 and the appliance 204. In case the user wants to have the devices automatically controlled by the service provider, a set of rules are first defined to the portal. For this purpose, a define rule request containing rule data is sent to the portal (arrow 910). The rule data contains rules, whereby one rule has two parts. The first part includes one condition: This condition is an expression, that can be evaluated to TRUE or FALSE by the portal 202 using device data, event IDs, service point data or a combination of such data. The rule's secondary part contains up to three actions: A device command to be sent to the appliance 204 in case the condition evaluates to TRUE, a service point command to be sent to the service provider 206 in case the condition evaluates to TRUE, and a new internal event to be raised in case the condition evaluates to TRUE (arrow 924).

If one of the specified actions is a service point command, the portal checks the service point command by sending a check command request to the service provider (arrow 912). A Service Point Command can be represented by an XML-document. A flag indicating the success of the check is returned by the service provider to the portal (arrow 914). If one of the specified actions is a device command, the portal checks the device command using configuration data (arrow 916).

The search criteria for retrieving the configuration data is the user and the device. Then, the portal stores the rule data (arrow 918) and returns a define rule complete reply to the user (arrow 920). From this point in time to the actual occurrence of an event some time may pass as illustrated by the dotted line 922.

When the event corresponding to the specified event ID occurs provided by either the portal (arrow 924), the appliance (arrow 926) or by the service provider (arrow 928), the portal retrieves the appropriate rule data (arrow 930). Subsequently, the portal evaluates all conditions and performs all necessary actions, i.e., if according to an action a service point command is to be performed, the portal sends the service point command with the process request to the service provider (arrow 932). The service provider processes the service point command (arrow 934) and returns service point data to the portal (arrow 936). The service point data may be represented by an XML document. The returned service point data is stored by the portal (arrow 938).

If an action device command is to be performed, the portal sends the device command with the process request to the appliance (arrow 940). The appliance processes the device command (arrow 942) and returns device data to the portal (arrow 944). After having stored all resulting device data for the rule (arrow 946), the portal checks if the rule contains an action related to an internal event and generates this internal event, if necessary (arrow 948). In a last step, the portal appends an entry to the event log (arrow 950).

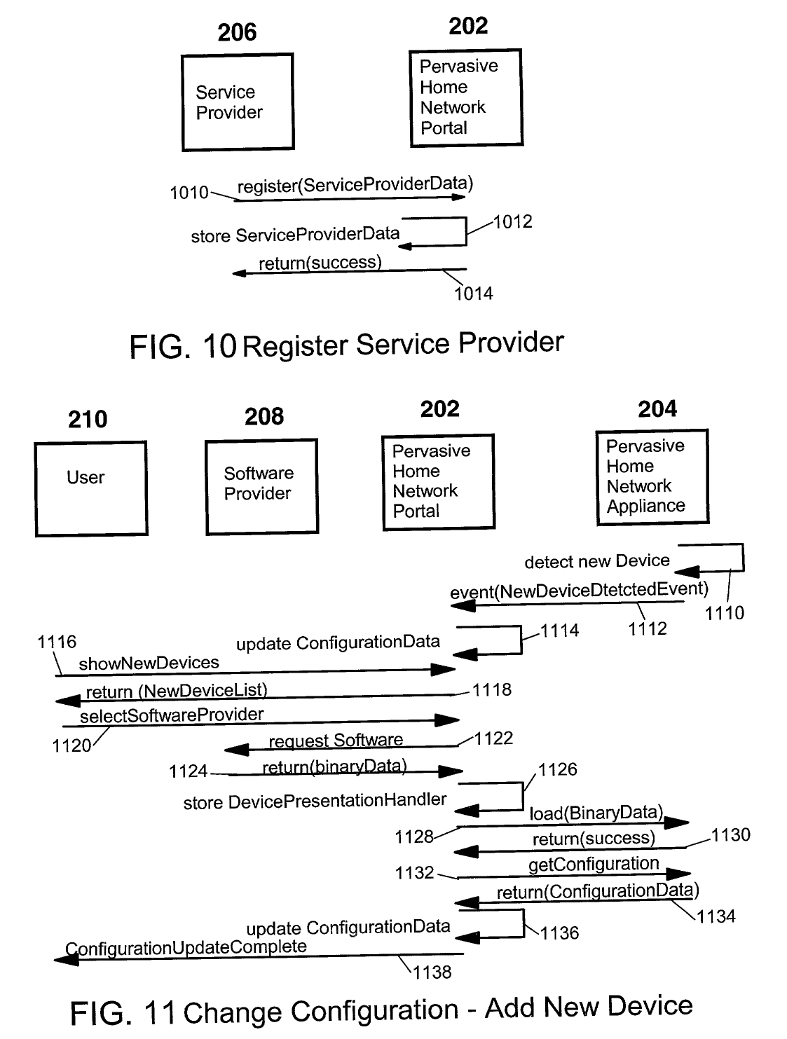

With reference now to FIG. 10, there is depicted a flowchart illustrating a method of a registration of a service provider to a portal in accordance with the present invention. In this scenario, the communication takes place between the service provider 206 and the portal 202. Whenever a service provider wants to offer his services to users of the portal, he first has to store its access data at the portal. Therefore he sends a register service provider request to the portal containing service provider data (arrow 1010). Service provider data can be represented by an XML document. The portal stores the Service Provider Data (arrow 1012) and returns a flag indicating the success of the transaction to the service provider (arrow 1014).

With reference now to FIG. 11, there is depicted a flowchart illustrating a method of changing the configuration of the user's devices by adding a new device in accordance with the present invention. In this scenario, the communication takes place between the user 210, the software provided 208, the portal 202 and an appliance 204. Assuming that the user adds a device in his home network, the appliance detects the new device (arrow 1110). The appliance then sends a special event, namely, the new device detected event, to the portal (arrow 1112). The special event contains the new device's properties. In return, the portal updates the configuration data by adding the new device's properties to the appropriate configuration file (arrow 1114). Later on, when the user wants to check the configuration at the portal, a show new devices request is sent to the portal (arrow 1116). In response, the portal returns a new device list containing all recently detected devices with their properties (arrow 1118). Among other things, these properties contain a reference to a software provider.

Then, the user selects a software provider and then sends to the portal a select software provider request with the reference to the selected software provider (arrow 1120). The portal uses the reference, which can be represented by a URL, to request software in form of binary data from the selected software provider (arrow 1122). The binary data may have two parts. One part is dedicated to the appliance and the other part is dedicated to the portal representing the device presentation handler mentioned above. Subsequently, the portal stores the device presentation handler (arrow 1126) and sends a load request containing the binary data to the appliance (arrow 1128), which in turn returns a flag confirming the reception of the binary data (arrow 1130). Then, the portal sends a get configuration request to the appliance (arrow 1132). Since new software has been applied to the appliance, it returns new configuration data to the portal (arrow 1134). After having updated the configuration data (arrow 1136), the portal returns a configuration update complete reply to the user (arrow 1138).

The present invention can be realized in hardware, software, or a combination of hardware and software. Any kind of computer system, or other apparatus adapted for carrying out the methods described herein is suited to implement the present invention. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system, is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

Although certain preferred embodiments have been shown and described, it should be understood that many changes and modifications may be made therein without departing from the scope of the appended claims.

1. A method for operating a home network by providing communication and control from a user to an appliance, via a distributed information system, by using a mediator, the method comprising the following steps performed by said mediator:
receiving a message from said user containing a generic command to control at least one device included in said home network;
converting said generic command into an appliance specific command;
sending said appliance specific command to said appliance to be processed by converting said appliance specific command into a device specific command;
receiving a response message from said appliance;
converting said response message into a generic format;
retrieving a device presentation handler;
converting, by said device handler, said response message from said generic format into a generic markup language, and
sending the response message in said generic markup language to said user.

2. The method according to claim 1, wherein the step of converting said generic command into an appliance specific command further comprises the steps of:
retrieving configuration data specific to said device being controlled; and
adding such configuration data to the generic command.

3. The method according to claim 2 wherein the generic command is formed by a query for specific device information.

4. The method according to claim 2, wherein the generic command is formed by a request for specific behavior of said appliance.

5. The method according to claim 3, further comprising the steps of:
receiving a request from said user to store a set of generic commands under a unique command identifier;
converting said generic commands by retrieving configuration data and adding said configuration data to the generic commands; and
storing said converted commands.

6. The method according to claim 5, further comprising the steps of:
receiving a message from said user including said unique command identifier;
retrieving said converted commands stored under said unique command identifier;
sending said converted commands to said appliance to be processed;
receiving a response message from said appliance;
converting said response message into a generic format; and
sending the converted response message to said user, by invoking the device presentation handler.

7. The method according to claim 1, further comprising the steps of:
receiving a request from the user to store a rule specifying an action to be executed whenever a specified event occurs;
verifying said action; and
storing said rule.

8. The method according to claim 7, further comprising the steps of:
detecting said specified event;
retrieving and evaluating said stored rule; and
executing said specified action when the rule is evaluated to be true.

9. The method according to claim 8, further comprising the steps of:
receiving a response message from said appliance;
converting said response message into a generic format;
sending the converted response message to said user by invoking the device presentation handler.

10. The method according to claims 9 wherein the step of detecting said specified event includes the step of receiving a message from a service provider indicating the occurrence of said event.

11. The method according to claim 9 wherein the step of detecting said specified event includes the step of receiving a message from said appliance indicating the occurrence of said event.

12. The method according to claim 10, wherein the step of detecting said specified event includes the step of generating said event.

13. The method according to claim 2 further comprising the steps of:
receiving a message indicating the presence of a new device registered with said appliance;
updating said configuration data;
requesting respective software from a specified software provider;
receiving the requested software; and
forwarding said requested software to said appliance.

14. The method according to claim 1 wherein the step of converting said response message from said generic format into a generic markup language includes the step of converting said response message into one of the formats of the group of HTML, XML, VoiceXML, WML.

15. The method according to claim 1 wherein the distributed information system is the Worldwide Web.

16. The method according to claim 15 wherein said user accesses the Worldwide Web by invoking a web browser to access a set of web applications forming an Internet web site.

17. An apparatus including a network portal that operates a home network by providing communication and control from a user to an appliance, via a distributed information system, comprising:
means for receiving a message from said user containing a generic command to control at least one device included in said home network;
means for converting said generic command into an appliance specific command;
means for sending said appliance specific command to said appliance to be processed by converting said appliance specific command into a device specific command;
means for receiving a response message from said appliance;
means for converting said response message into a generic format;
means for retrieving a device presentation handler;
means for converting, by said device handler, said response message from said generic format into a generic markup language, and
means for sending the response message in said generic markup language to said user.

18. The apparatus according to claim 17 wherein the means for converting said generic command into an appliance specific command further comprises:
means for retrieving configuration data specific to said device being controlled; and
means for adding such configuration data to the generic command.

19. The apparatus according to claim 18 wherein the generic command is formed by one of a query for specific device information and a request for specific behavior of said appliance.

20. The apparatus according to claim 19, further comprising:
means for receiving a request from said user to store a set of generic commands under a unique command identifier;
means for converting said generic commands by retrieving configuration data and adding said configuration data to the generic commands; and
means for storing said converted commands.

21. The apparatus according to claim 20 further comprising:
means for receiving a message from said user including said unique command identifier;
means for retrieving said converted commands stored under said unique command identifier;
means for sending said converted commands to said appliance to be processed;
means for receiving a response message from said appliance;
means for converting said response message into a generic format; and
means for sending the converted response message to said user, by invoking the device presentation handler.

22. The apparatus according to claim 17, further comprising:
means for receiving a request from the user to store a rule specifying an action to be executed whenever a specified event occurs;
means for verifying said action; and
means for storing said rule.

23. The apparatus according to claim 22, further comprising:
means for detecting said specified event;
means for retrieving and evaluating said stored rule; and
means for rexecuting said specified action when the rule is evaluated to be true.

24. The apparatus according to claim 23, further comprising:
means for receiving a response message from said appliance;
means for converting said response message into a generic format;
means for sending the converted response message to said user by invoking the device presentation handler.

25. The apparatus according to claim 24 wherein the means for detecting said specified event includes means for receiving a message from a service provider indicating the occurrence of said event.

26. The apparatus according to claim 24 wherein said means for detecting said specified event includes means for receiving a message from said appliance indicating the occurrence of said event.

27. The apparatus according to claim 25, wherein the means for detecting said specified event includes means for generating said event.

28. The apparatus according to claim 18 further comprising:
means for receiving a message indicating the presence of a new device registered with said appliance;
means for updating said configuration data;
means for requesting respective software from a specified software provider;
means for receiving the requested software; and
means for forwarding said requested software to said appliance.

29. The apparatus according to claim 17 wherein the means for converting said response message from said generic format into a generic markup language includes means for converting said response message into one of the formats of the group of HTML, XML, VoiceXML, WML.

30. The apparatus according to claim 17 wherein the distributed information system is the Worldwide Web.

31. The apparatus according to claim 30 wherein said user accesses the Worldwide Web by invoking a web browser to access a set of web applications forming an Internet web site.

32. A system that controls environmental conditions in a facility, comprising:
a user interface, connected to a distributed information system, that provides a command included in a generic control message;
at least one device, for controlling elements in said facility, that communicates using a device specific command;
a network portal connected to said distributed information system for enabling said user interface to communicate with said at least one device, through said network appliance, by converting said generic control message into a network appliance specific command; and
a network appliance connected to said at least one device and said distributed information system that translates said network appliance specific command to said device specific command;
wherein said network portal provides communication and control between said user interface and said device to regulate the environmental conditions in said facility by presenting data associated with said at least one device to said user interface and providing control information from said user interface to said at least one device.

33. A system according to claim 32 wherein said distributed information system is the Worldwide Web.

34. A system according to claim 33 wherein said user interface comprises a plurality of distinct Worldwide Web compatible hardware.

35. A system according to claim 34 wherein said network portal provides communication between any one of said distinct Worldwide Web compatible hardware and any of said plurality of said devices, independent of any associated distinct communication protocol.

36. A system according to claim 35 wherein said network portal provides automatic control of said facility by storing user defined rules which cause commands to be sent to said device in accordance with various user inputs.

37. A system according to claim 36 further comprising an Internet service provider that sends a communication of various external criteria which causes said rules to issue said commands to said device.

38. A system according to claim 37 wherein said external criteria include a weather forecast.

39. A computer program product stored on a computer readable media that includes executable program instructions for operating a home network by providing communication and control from a user to an appliance, via a distributed information system, by using a mediator, the method comprising the following steps performed by said mediator:
instruction means for receiving a message from said user containing a generic command to control at least one device included in said home network;
instruction means for converting said generic command into an appliance specific command;
instruction means for sending said appliance specific command to said appliance to be processed by converting said appliance specific command into a device specific command;
instruction means for receiving a response message from said appliance;
instruction means for converting said response message into a generic format;
instruction means for retrieving a device presentation handler;
instruction means for converting, by said device handler, said response message from said generic format into a generic markup language, and
instruction means for sending the response message in said generic markup language to said user.

40. The computer program product according to claim 39, wherein the instruction means for converting said generic command into an appliance specific command further comprises:
instruction means for retrieving configuration data specific to said device being controlled; and
instruction means for adding such configuration data to the generic command.
